(19) United States
(12) Patent Application Publication
(10) Pub. No.: US 2004/0117284 A1
(43) Pub. Date: Jun. 17, 2004

(54) Method of creating a shared weighted index

(76) Inventor: William M. Speth, Evanston, IL (US)

Correspondence Address: Bell, Boyd & Lloyd LLC, P.O. Box 1135, Chicago, IL, 60690-1135, US

(21) Appl. No.: 10/317,557

(22) Filed: Dec. 11, 2002

(51) Int. Cl. G06F 17/60

(52) U.S. Cl. 705/36

(57) ABSTRACT

The present invention relates to a method for creating a share-weighted index which is intended to replicate the investment return of a “buy-and-hold” portfolio of assets, as well as a method of trading derivative investment products based on such an index. The components of a share-weighted index according to the present invention are selected to reflect the index designer's desired investment exposure. The weight of each component is determined by the component's price multiplied by an adjustment factor. The adjustment factor is chosen to yield an initial index weight deemed appropriate by the designer of the index. The weighted prices of all component are then added together and divided by a common divisor.

### BACKGROUND OF THE INVENTION

The present invention relates to the creation of shared-weighted stock indexes and derivative investment products based on such indexes. Stock market indexes are well known in the art, as are the many derivative investment products, such as futures and options contracts, that may be traded based on such indexes. Well known U.S. based stock market indices include the Dow Jones Industrial Average, the S&P 500 and the NASDAQ composite index.

In recent years new indexes have become available which allow investors to make highly focused investment decisions that can be tailored to fit particular market outlooks or specific investment strategies. Indexes may be calculated to reflect broad market performance or they may be calculated to reflect the market conditions of highly specific market segments. For example, the S&P 500 is considered a broad market index, whereas other indexes may focus on a single industry such as automotive, or telecom stocks. Alternatively, indexes can be created to reflect the performance of specific sized companies and so forth.

As the number and type of indexes proliferate, so do the methods for calculating index values and for selecting the component stocks that make up the indexes. With the exception of the method of the present invention there are four basic methods for calculating index values. These are capitalization weighted, price-weighted, equal dollar weighted, and modified equal dollar weighted. Each of these methods have advantages and disadvantages, depending on the intended focus of the index.

A capitalization weighted index is calculated based on the current stock price and market capitalization of each component of the index. The last transaction price for each stock in the index is multiplied by the number of outstanding common shares to give the market capitalization for each company in the index. The sum of the market capitalizations of all components determines the total capitalization for the index. The total market capitalization is then divided by an index divisor to scale the index to a desired reference level, such as a round multiple of 100 to establish a baseline for gauging future performance of the index. In a capitalization weighted index a given percentage change in a particular component stock will affect the overall value of the index in direct proportion to the stock's relative market value. Thus, the price fluctuations of larger companies will predominate over those of smaller capitalized companies.

In a price-weighted index, on the other hand, the influence of one or two exceptionally large companies among a number of smaller companies can be moderated somewhat. The value of a price-weighted index is calculated by simply adding together the last transaction price for each stock in the index and dividing the resulting sum by an index divisor to scale the index. According to a price-weighted index, a given percentage change in a component stock will affect the overall value of the index in direct proportion to the stock's price relative to the prices of the other stocks in the index. For example, a dollar change in the price of any component stock will have the same affect on the index regardless of which stock changes price. An advantage of this weighting method is its transparency to users, its simplicity, and its moderating effects on the influence of exceptionally large component companies. On the other hand price-weighting distorts the true picture of the market provided by the index somewhat in that it tends to ignore the full market impact of the larger components of the index.

Equal-dollar-weighted indexes and modified-equal-dollar-weighted indexes are somewhat more complex. In equal-dollar weighted indexes the weights of each component are reset to equal values at regular intervals, such as for example, every quarter. Between re-adjustments the weights of the various index components will deviate from the equal-dollar weighting values as the values of the components fluctuate. In a modified equal-dollar-weighted index the weights of the component stocks are reset at regular intervals, but not necessarily to equal values. Instead some other rule may be applied to apportion weight of the index components.

Periodically indexes must be adjusted in order to reflect changes in the component companies comprising the index, or to maintain the original intent of the index in light of changing conditions in the market. For example, if a component stock's weight drops below an arbitrary threshold, or if a component company significantly alters its line of business or is taken over by another company so that it no longer represents the type of company which the index is intended to track, the index may no longer be influenced by, or reflect the aspects of the mark for which it was originally designed. In such cases it may be necessary to replace a component stock with a suitable replacement stock. If a suitable replacement which preserves the basic character of the index cannot be found, the stock may simply be dropped without adding a replacement. Conversely if activity in the market for which an index is created dictates, a new stock which was not originally included in the index may be having such a strong impact in the market that it should be added to the index to adequately reflect the market without eliminating other components. In each case, the divisor may be adjusted so that the index remains at the same level immediately after the new stock is added or the old stock is eliminated.

Corporate actions such as takeovers and mergers, extraordinary dividends or splits can also necessitate adjustments to an index to ensure continuity of the index. Different types of corporate actions will have different effects depending on the type of index. For instance, a two-for-one stock split in one of the components of an index which halves the share price of the company but leaves the total capitalization intact would alter the value of a price weighted index, but would not alter the value of a capitalization-weighted index. Thus, a two-for-one stock split in a component company would require an adjustment to the divisor in the price weighted index, but not in the capitalization index. The table shown in FIG. 1 indicates the various corporate actions that may require index adjustments and the types of indexes that would require such adjustments.

Indexes computed according to the weighting methods described above provide a particularized view of a given market segment. The market segment is determined by the type of components selected for the index and the value of the index is directly related to the type of weighting. Thus, the index will provide a somewhat skewed view of the selected market segment depending on the type of weighting used. Such indexes do not reflect the performance of actual stock portfolios comprising the component stocks of the index held in various ratios to one another.

### SUMMARY OF THE INVENTION

The present invention relates to a method for creating a share-weighted index which is intended to replicate the investment return of a “buy-and-hold” portfolio of assets, as well as a method of trading derivative investment products based on such an index. According to an embodiment of the invention the individual component stocks selected for inclusion in the index are weighted by selecting an adjustment factor for each index component and adjusting a current share price of each index component by multiplying the share price by the adjustment factor. The weighted index may be formed by summing the weighted components and dividing the sum by a divisor.

In another embodiment of the invention, a method of creating a stock index includes the steps of selecting a limited number of index component stocks related by a common theme, share weighting each component, and generating an index value by summing each share-weighted component. Examples of common themes may include industry sector, market capitalization, trading activity, volatility, the number of outstanding shares, share price, and the like. Stocks which relate to the selected theme may be selected by generating a score for each stock based on a plurality of factors and selecting a limited number of stocks from among the stocks having the highest scores.

Further, the invention also encompasses a method of trading derivative financial instruments based on a share-weighted index. According to this embodiment a share-weighted index of stocks is created wherein the component stocks are related by common theme, and derivative investment contracts are created whose value is based on the performance of the share-weighted index.

Additional features and advantages of the present invention are described in, and will be apparent from, the following Detailed Description of the Invention and the figures.

### BRIEF DESCRIPTION OF THE FIGURES

FIG. 1 is a table showing the types of corporate actions which may require an index to be adjusted, as well as which types of weighting methods will be affected by the various corporate actions.

FIG. 2 is a flow chart showing a process for creating a share-weighted index according to the present invention.

FIG. 3 is a flow chart showing a method for selecting the components of a share-weighted index.

FIG. 4 shows a listing for a share-weighted index according to the present invention.

FIG. 5 shows a listing of the share-weighted index of FIG. 4 after being adjusted to reflect a 2-1 stock split of one of the component stocks.

FIG. 6 shows the listing of the share-weighted index of FIG. 4 after being adjusted to reflect a special 5% stock dividend.

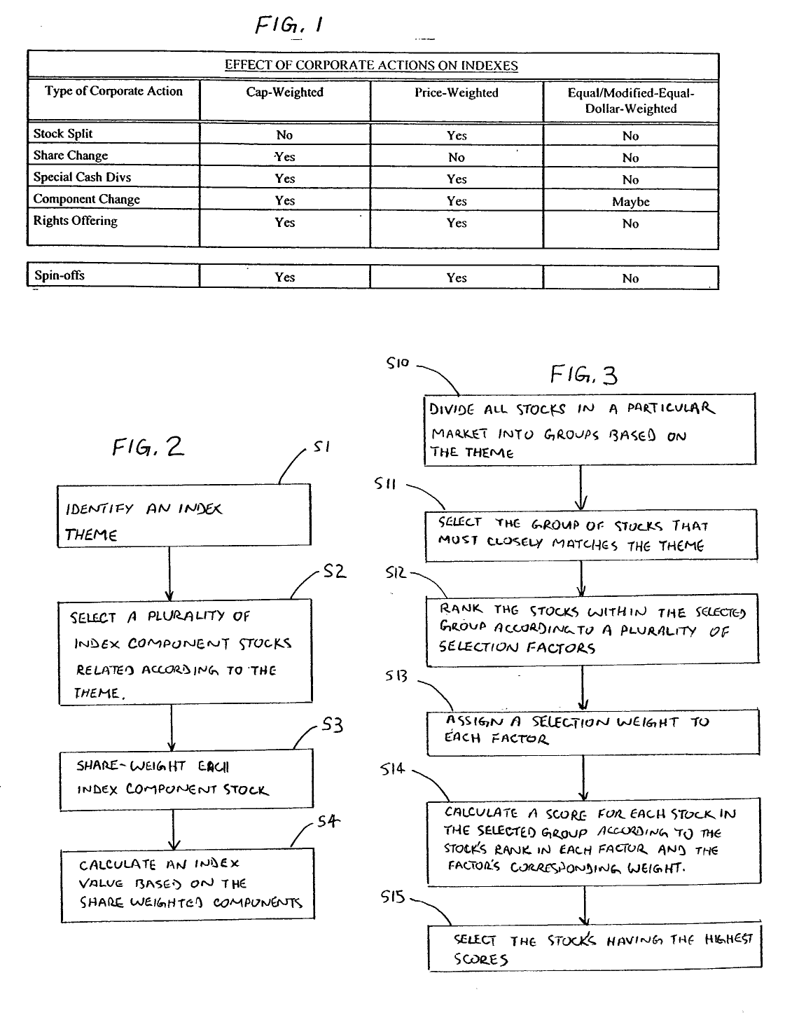

### DETAILED DESCRIPTION OF THE INVENTION

The present invention relates to a method for creating a share-weighted index which is intended to replicate the investment return of a “buy-and-hold” portfolio of assets, as well as a method of trading derivative investment products based on such an index. The components of a share-weighted index according to the present invention are selected to reflect the index designer's desired investment exposure. The weight of each component is determined by the component's price multiplied by an adjustment factor. The adjustment factor is chosen to yield an initial index weight deemed appropriate by the designer of the index. The weighted prices of all component are then added together and divided by a common divisor.

FIG. 2 shows a flow chart of a process for creating a share-weighted index according to the present invention. The first step S1 requires the index designer to select a theme around which the index is to be based. The selected theme may be based on a specific industry sector or a specific level of market capitalization or any other characteristic by which companies can be categorized and distinguished. A small sample of possible themes include market sectors such as biotech, defense, energy, high-tech, and so forth. Market capitalization themes may include small-cap, mid-cap or large-cap companies, corporate giants, industry leaders, and the like.

Once a theme for an index has been selected, it is necessary to select the component stocks that will make up the index, as indicated in step S2. Of course, the selected stocks will all be related according to the common theme. For example, an index of “Corporate Giants” may be created having the stocks of the largest most highly capitalized corporations as components. A preferred method of selecting the most appropriate stocks according to a selected theme is discussed in more detail below with reference to FIG. 3. For present purposes, however, it is sufficient to note that a small group of stocks related to one another according to the selected theme are chosen to be components of the index. Preferably the selected stocks are the stocks most relevant to the theme selected from among a large group of relevant stocks.

The next step in the process of creating a share-weighted index is step S3 where each of the selected component stocks is weighted. According to the present invention, each component stock is weighted by multiplying the current price of the stock by an adjustment factor. The adjustment factor is an arbitrary multiplier selected by the designer of the index. Since the index of the present invention is intended to replicate the investment return of a “buy-and-hold” portfolio of assets (the components of the index) the adjustment factor for each component may be selected to represent the investment exposure to each component deemed appropriate by the designer of the index.

Once the weight of each component has been determined, the index value may be calculated as shown in step S4. The index value is calculated by summing the weighted values of all of the components and dividing by a divisor. The value of the divisor is selected to yield a convenient baseline value at the inception of the index against which future performance may be compared. For example, the divisor may be selected such that the initial value of the index is 100.00 or some multiple thereof to provide an easy point of comparison for the index's future performance. The complete formula for calculating the index value according to the present invention may be expressed as:

$${I}_{value} = \frac{{\sum }_{i = 1}^{N} {P}_{i , t} \times {A}_{i}}{Divisor}$$

Where: N=The total number of components in the index.

P_{i,t}=The price of i^{th} component at time t.

Aₜ=The adjustment factor of the i^{th} component.

Turning to FIG. 3, a method for selecting the components of a share-weighted index according to the present invention will now be described. The method steps outlined in FIG. 3 are performed after a theme has been selected for the index being created. At step S10 all of the stocks in a particular market, i.e. the total pool of stocks from which index components are to be selected, are divided into groups according to the theme. For example, the total pool of stocks may be designated as all stocks listed on a particular exchange, or all stocks traded in a national market and so forth. The stock pool may then be divided based on capitalization (i.e. small-cap, mid-cap, large-cap) or industry segment (energy, communication, retail, etc.), and the like. The group that matches the selected theme for the index becomes the more limited pool from which the components will be selected. For example, if the overall pool is divided based on market capitalization and the selected index theme is “Corporate Giants” the group of stocks containing the stocks of companies having the largest market capitalization will be selected as the pool from which the index components will be drawn.

Once a group of stocks has been selected, the stocks within the group are ranked according to a plurality of weighted factors. Some of these factors may include:

Name recognition

Stock price and stock price volatility

Market capitalization

Number of outstanding shares

Percentage of outstanding shares available for investment

Stock trading activity

Derivatives trading activity

Correlation with other stocks in the group

Each stock in the group is given a score based on its rank within each category and the corresponding weight assigned to each category. The stocks having the highest scores are then selected for the index. For example, if the index is to consist of five stocks then the stocks having the 5 highest scores are selected for inclusion in the index.

A share-weighted index constructed as described above is designed to measure the performance of a portfolio containing the component stocks held in round-lot aggregations. Thus, it is necessary to determine the initial portfolio holdings or the weight given to each component of the index. There is any number of ways this can be accomplished, ranging from arbitrary selection of weighting factors to detailed mathematical formulas.

One such formula is an iterative process described as follows. A “factor placeholder” (FP) having an arbitrary initial value such as $1000 is assigned to each component. Each FP is then divided by the primary market price of the corresponding index component. The results are then rounded to the nearest increment of 25 shares. If the rounded value of any component is 0 each FP is incremented by 1000 and the process is repeated. The rounded values may then serve as the initial adjustment factors for the components of the index. These values are multiplied by their corresponding component share price and added together. A divisor is then selected which when the sum of the adjustment factor share price products is divided by the divisor, a desired initial index value is achieved.

Next, two examples will be described of corporate actions which will affect an index component's share price, and which will require an adjustment to the index. These examples are provided for illustrative purposes only. It will be understood that other corporate actions not described herein may be accounted for in a similar manner. FIG. 4 shows a share-weighted index according to the present invention entitled Corporate Giants. The listing 10 shown in FIG. 4 includes a ticker symbol 12, company name 14, an exchange on which the stock is traded 16, a current price 18, a share-factor 22, and the component weight 24 within the index, for each component of the index. In the example shown in FIG. 4, the component stocks are Microsoft Corp. 26, General Electric 28, Walmart Stores Inc. 30, Exxon Mobil Corporation 32 and Pfizer, Inc. 34. The name of the index 36 is Corporate Giants Series I, 2002. The divisor 38 is 100.00.

As described above, the index value 40 is calculated by summing the share price of each component stock multiplied by the component's adjustment factor and dividing by the divisor. In the example of FIG. 4, the sum total of all the share prices multiplied by their respective adjustment factors is 6149.00. This leads to the 61.49 index value when divided by the divisor 100.00. According to the example, Microsoft's share price is 48.87 and the adjustment factor is 25.00, leading to a weighted value of 1221.75 which is 19.87% of the total weight of the index. The General Electric Co. share price is approximately one-half the Microsoft share price, but the G.E. adjustment factor is 50, twice the value of the Microsoft adjustment factor. Thus, the G.E. share price multiplied by the G.E. adjustment fact 50 leads to a weighted value of $1210.5 or 19.69% of the total weight of the index, nearly equal to the weight of the Microsoft component. The Walmart component has a share price of $53.83 and an adjustment factor of 25. Thus, the Walmart component has a total weighted value of 1,345.75 or 21.89% of the total weight of the index. For Exxon Mobil, the share price is 34.54, the adjustment factor is 25, for a weighted value of 863.50 or 14.04% of the total index weight. Finally, Pfizer Inc.'s share price is $30.15 with an adjustment factor of 50, for a weighted value of 1,507.50 or 24.52% of the total weight of the index.

An index adjustment will now be described with reference to FIG. 4, illustrating the ease with which the index value and the relative weights of the component stocks may be maintained in the face of a 2-1 stock split in one of the component stocks. The listing 10 of FIG. 5 is substantially identical to that shown in FIG. 4 except for the data relating to the Walmart Stores, Inc. component of the index. Walmart shares have experienced a 2-1 split, doubling the number of outstanding shares and halving the share price. To compensate for the reduced share price the adjustment factor is adjusted by the reciprocal amount. Thus, whereas the Walmart Stores, Inc. share price is halved to $26.92, the Walmart Stores, Inc. adjustment factor is doubled to 50.00. As a result, the share price x adjustment factor, the weighted value of the Walmart component of the index remains the same at 1345.75. Furthermore, the index value remains the same at 61.49, and the weight of the Walmart Stores Inc. component of the index remains unchanged at 21.89%.

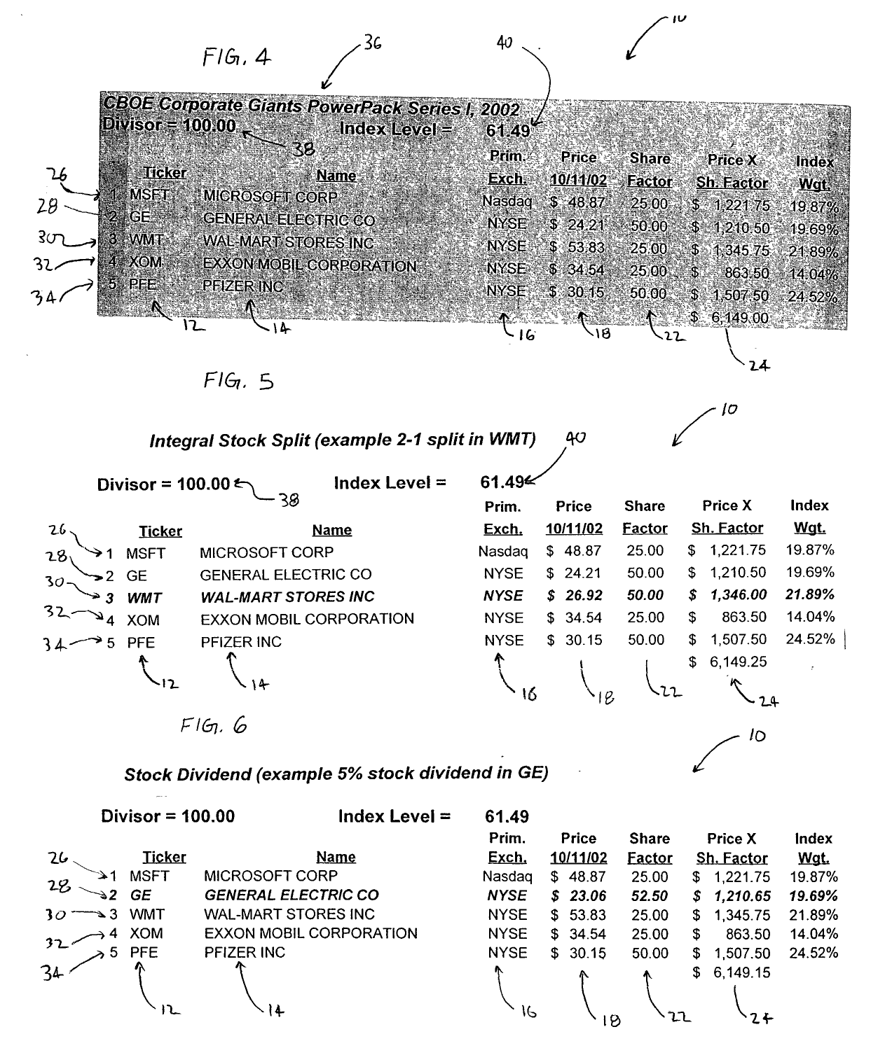

Next, a slightly more complicated adjustment relating to a 5% stock dividend will be described in relation to FIG. 5. Again, the listing shown in FIG. 6 is substantially the same as that shown in FIG. 4. Except that in this case the listing for the General Electric component has been altered to reflect a special 5% stock dividend. The G.E. share price has been reduced by 5% to $23.06 to reflect the special dividend. Meanwhile, the G.E. adjustment factor is adjusted upward a corresponding amount to 52.50 to compensate for the reduced share price. Thus, the product of the share price x adjustment factor remains the same at 1,210.65, preserving the G.E. component's 19.69% weight in the overall index.

Other corporate actions may be addressed in a similar manner. For example, non-integral stock splits, special cash dividends, spin-offs and other distributions of property, may all be taken into account by adjusting the corresponding adjustment factor. The original divisor remains unchanged.

Once an index has been created according to the present invention, derivative investment products such as index futures contracts and options contracts may be created and traded based on the index. Such derivative products are traded in the same manner as traditional derivatives. Contracts can be listed in series on an exchange, investors take long and short positions in anticipation of the direction they believe the index is heading, and the corresponding contracts are traded according to the rules of the exchange. Contracts can also be traded in an over the counter market. All such contracts are cash settled upon expiration.

One of the advantages behind the share-weighted indexes of the present invention is that in one embodiment they allow investors to make highly focused investments which reflect the performance of a buy-and-hold portfolio of stocks. In one embodiment the indexes are narrowly focused and investor interest in various indexes will likely wax and wane according to the whim of the market. Therefore, flexibility in creating new indexes and retiring old indexes is highly desirable.

Derivatives based on a particular index may be packaged as groups or series. Each series may then be reviewed to assess investor interest and changing market conditions. Based on the results of such an assessment new series of derivative contracts based on newly created indexes may be introduced, while previous series based on existing indexes are allowed to expire.

A transition period may be provided wherein investors may “roll” old contracts into new contracts based on a new series. For example, on the first day of a month in which an existing series of contracts is set to expire, a new series of contracts based on the same or a similar index may be introduced. As of the expiration date of last expiring derivatives in the previous series the entire series itself expires, and the corresponding contracts disappear. When the new series is introduced, a one-year price history for the associated index (be it an existing index or a new index) may be published.

As an example, suppose that November and December options are currently listed on an exchange, for a biotech index series 2002. Suppose further that the index is set to expire in December. The exchange could begin listing contracts for a biotech index series 2003 on Monday, Dec. 2, 2002, with options expiring in January 2003 and February 2003. During the period between December 2, and the December expiration, both series of contracts would be available for trading, after the December expiration, however, only the biotech index series 2003 contracts would be available for trading. Each index option contract would trade under a distinct trading symbol in much the same way LEAPS options are listed. If there is no longer sufficient interest in the index, the 2003 series need not be listed.

Thus, a method of creating a share weighted index and a method of trading derivative investment products based on such indexes are provided. It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method of weighting individual components of a multi-component stock index comprising the steps of:
selecting an adjustment factor for each index component;
adjusting a current share price of each index component according to the component's adjustment factor; and
summing the adjusted current share prices of each index component.

2. The method of claim 1 further comprising the step of dividing the sum of the adjusted current share prices of each index component by divisor.

3. The method of claim 1 further comprising the step of adjusting the weight of an index component to reflect corporate actions affecting the current share price of the index component without effecting the index value.

4. The method of claim 3 wherein the step of adjusting the weight of an index component comprises changing the value of the adjustment factor of the index component.

5. A method of creating a narrowly focused stock index, the method comprising the steps of:
selecting a limited number of index component stocks related by a common theme;
share weighting each component; and
generating an index value by summing each share-weighted component.

6. The method of claim 5 wherein the common theme is selected from the group of themes comprising: industry sector, market capitalization, trading activity volatility, number of outstanding shares, and share price.

7. The method of claim 5 wherein the step of selecting a limited number of index component stocks comprises:
identifying a plurality of stocks related by the theme;
generating a score for each stock based on a plurality of factors; and
selecting the limited number of stocks from among the stocks having the highest scores.

8. The method of claim 7, wherein said plurality of factors includes at least one of: name recognition; stock price; stock price volatility; market capitalization; number of outstanding shares; percentage of shares available for investment; stock trading activity; derivatives trading activity; and correlation with other stocks in the group.

9. The method of claim 7, wherein the step of generating a score for each stock based on a plurality of factors further comprises the steps of:
assigning a weight to each factor ranking each stock according to each factor;
for each factor multiplying each stock's rank by the weight assigned to the factor; and
adding all of the weighted rankings for each stock.

10. A method of selecting a specified number of stocks for inclusion in a narrowly focused stock index, the method comprising the steps of:
identifying a theme;
identifying a plurality of stocks related by said theme;
generating a score for each stock based on a plurality of factors; and
selecting the specified number of stocks from said plurality of stocks having the highest scores.

11. The method of claim 10, wherein said plurality of factors includes at least one of: name recognition; stock price; stock price volatility; market capitalization; number of outstanding shares; percentage of shares available for investment; stock trading activity; derivatives trading activity; and correlation with other stocks in the group.

12. The method of claim 10, wherein the step of generating a score for each stock based on a plurality of factors further comprises the steps of:
assigning a weight to each factor ranking each stock according to each factor;
for each factor multiplying each stocks rank by the weight assigned to the factor; and
adding all of the weighted rankings for each stock.

13. A method of trading derivative financial instruments comprising the steps of:
selecting a theme;
creating a narrowly focused share-weighted index of stocks related by said theme;
creating investment contracts based on the performance of the share-weighted index.

14. The method of claim 13 wherein said theme is selected from the group of themes comprising: industry sector, market capitalization, trading activity volatility, number of outstanding shares, and share price.

15. The method of 13 wherein said step of creating a narrowly focused share-weighted index further comprises:
selecting a limited number of stocks related according to said theme;
share-weighting each stock; and
summing each share-weighted stock.

16. The method of claim 15 further comprising the step of calculating an index value by dividing the sum of said share-weighted components by a divisor.

17. The method of claim 13 further comprising the step of listing said investment contracts on an exchange.

18. The method of claim 13 wherein said investment contracts comprise option contracts.

19. The method of claim 13 wherein said investment contracts comprise futures contracts.

20. The method of claim 15 wherein the step of selecting a limited number of stocks related according to said theme further comprises:
identifying a plurality of stocks related according to the theme;
generating a score for each stock based on a plurality of factors; and
selecting the limited number of stocks having the highest scores.

21. The method of claim 20, wherein said plurality of factors includes at least one of: name recognition; stock price; stock price volatility; market capitalization; number of outstanding shares; percentage of shares available for investment; stock trading activity; derivatives trading activity; and correlation with other stocks in the group.

22. The method of claim 20, wherein the step of generating a score for each stock based on a plurality of factors further comprises the steps of:
assigning a weight to each factor ranking each stock according to each factor;
for each factor multiplying each stocks rank by the weight assigned to the factor; and
adding all of the weighted rankings for each stock.

23. The method of claim 13 further comprising the step of trading said investment contracts in an over the counter market.
